(19) United States
(12) Patent Application Publication
(10) Pub. No.: US 2014/0091667 A1
(43) Pub. Date: Apr. 3, 2014

(54) ARMATURE AND MOTOR

(71) Applicant: Nidec Corporation, Kyoto (JP)

(72) Inventors: Yoshihiro UCHITANI, Kyoto (JP); Machiko FUKUSHIMA, Kyoto (JP); Hironori RENGI, Kyoto (JP)

(73) Assignee: Nidec Corporation, Kyoto (JP)

(21) Appl. No.: 13/971,000

(22) Filed: Aug. 20, 2013

(30) Foreign Application Priority Data
Sep. 29, 2012 (JP) 2012-218916

(51) Int. Cl. H02K 3/34

(52) U.S. Cl. CPC H02K 3/345
USPC 310/198

(57) ABSTRACT

In an armature, a plurality of teeth extending from an annular core back each include a projection portion arranged to extend in a circumferential direction from a circumferential side surface of the tooth. Insulators, each of which is attached to the stator core and is arranged to cover at least a portion of a separate one of the teeth, include an insulator contact surface arranged to be in contact with the projection portion. A portion of the projection portion and the insulator contact surface are arranged to be in contact with each other.

### BACKGROUND OF THE INVENTION

1. Field of the Invention

The present invention relates to an armature and a motor.

2. Description of the Related Art

An umbrella-less core is sometimes used as a stator core of an armature to design a magnetic circuit. The umbrellaless core refers to a core having an umbrellaless structure, in which stator teeth have no umbrella portions.

A stator described in JP-A 2008-312288 includes a stator core including stator teeth, insulating members, each of which includes an opening to be fitted to a separate one of the stator teeth, and stator coils, each of which is wound around a separate one of the insulating members. The openings are fitted to the respective stator teeth in a situation in which the stator core has been cooled. According to a method of fixing an insulator to the stator core disclosed in JP-A 2008-312288, each insulating member is fitted to a corresponding one of the stator teeth in a situation in which the stator teeth have shrunk as a result of cooling of the stator core, and when the stator teeth thereafter return to their original volume at ordinary temperatures, a gap between each insulating member and the corresponding stator tooth is reduced.

In the case of the method disclosed in JP-A 2008-312288, however, strict control of precision in dimensions of each component is required to fix the insulator to the stator core.

### SUMMARY OF THE INVENTION

Preferred embodiments of the present invention provide an armature which includes a stator core including an umbrella-less structure and which allows secure fixing of insulators.

An armature according to a preferred embodiment of the present invention includes a stator core including an annular core back and a plurality of teeth, insulators, and coils. The teeth are arranged to extend radially inward or radially outward from the annular core back. Each insulator is attached to the stator core and is arranged to cover at least a separate one of the teeth. Each coil is defined by a conducting wire wound around a separate one of the insulators. Each insulator includes a first resin member and a second resin member arranged in an axial direction or a circumferential direction. Each tooth includes a projection portion arranged to extend in the circumferential direction from a circumferential side surface of the tooth. The projection portion includes a projection portion contact surface arranged to face the core back. Each insulator includes an insulator contact surface arranged to face a tip of a corresponding one of the teeth. The insulator contact surface is arranged to be at least partly in contact with the projection portion contact surface of the projection portion of the corresponding tooth.

Preferred embodiments of the present invention are able to provide an armature which includes an umbrellaless core and which allows secure fixing of insulators.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view of a portion of an armature according to a first preferred embodiment of the present invention taken along a plane perpendicular or substantially perpendicular to an axial direction.

FIG. 2 is a cross-sectional view of a portion of the armature according to the first preferred embodiment taken along a plane perpendicular or substantially perpendicular to a direction of extension of a tooth.

FIG. 3 is a cross-sectional view of the armature according to the first preferred embodiment taken along a plane perpendicular or substantially perpendicular to the axial direction.

FIG. 4 is a cross-sectional view of a motor according to a second preferred embodiment of the present invention.

FIG. 5 is a cross-sectional view of a portion of an armature according to a modification of the first preferred embodiment of the present invention taken along a plane perpendicular or substantially perpendicular to the axial direction.

FIG. 6 is a cross-sectional view of a portion of an armature according to a modification of the first preferred embodiment of the present invention taken along a plane perpendicular or substantially perpendicular to a direction of extension of a tooth.

### DETAILED DESCRIPTION OF THE PREFERRED EMBODIMENTS

Hereinafter, preferred embodiments of the present invention will be described with reference to the accompanying drawings. It is assumed herein that a direction parallel or substantially parallel to a central axis of a motor is referred to by the term “axial direction”, “axial”, or “axially”, that directions perpendicular or substantially perpendicular to the central axis of the motor are referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and the shape of each member or portion and relative positions of different members or portions will be described based on this assumption. It should be noted, however, that the above definitions of the various directions are made simply for the sake of convenience in description, and should not be construed to restrict in any way the orientation of an armature or a motor according to any preferred embodiment of the present invention when in use.

### First Preferred Embodiment

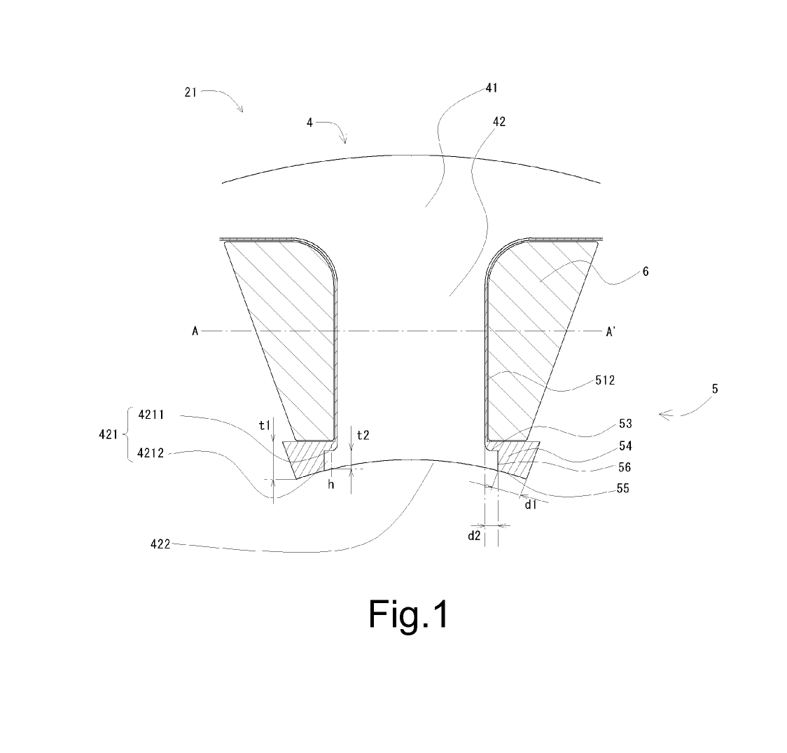

FIG. 1 is a cross-sectional view of a portion of an armature 21 according to a preferred embodiment of the present invention taken along a plane perpendicular or substantially perpendicular to the axial direction. Referring to FIG. 1, the armature 21 preferably includes a stator core 4, insulators 5, and coils 6.

The stator core 4 is preferably defined by, for example, a plurality of electromagnetic steel sheets placed one upon another in the axial direction. Each of the electromagnetic steel sheets is a magnetic body. The stator core 4 preferably includes a core back 41 arranged in an annular or substantially annular shape and a plurality of teeth 42 arranged to extend radially inward from the core back 41. Note that the teeth 42 may be arranged to extend radially outward from the core back 41.

An upper surface, a lower surface, and circumferential side surfaces of each of the teeth 42 are covered with a separate one of the insulators 5. Each coil 6 is preferably defined by a conducting wire wound around a separate one of the insulators 5.

Each tooth 42 preferably includes a tooth tip surface 422 and projection portions 421 each of which is arranged to extend in a circumferential direction from a separate one of the circumferential side surfaces of the tooth 42. Each projection portion 421 is preferably arranged at a tip portion of the tooth 42, and moreover, a base portion of the projection portion 421 is preferably arranged to be continuous with the tooth tip surface 422. This arrangement contributes to minimizing a reduction in space factor.

Each projection portion 421 preferably includes a tip portion 4212 and a “projection portion contact surface” 4211 arranged to face the core back 41. It is desirable that both the radial thickness and the circumferential width of the projection portion 421 should be minimized to increase the space factor of the coil 6.

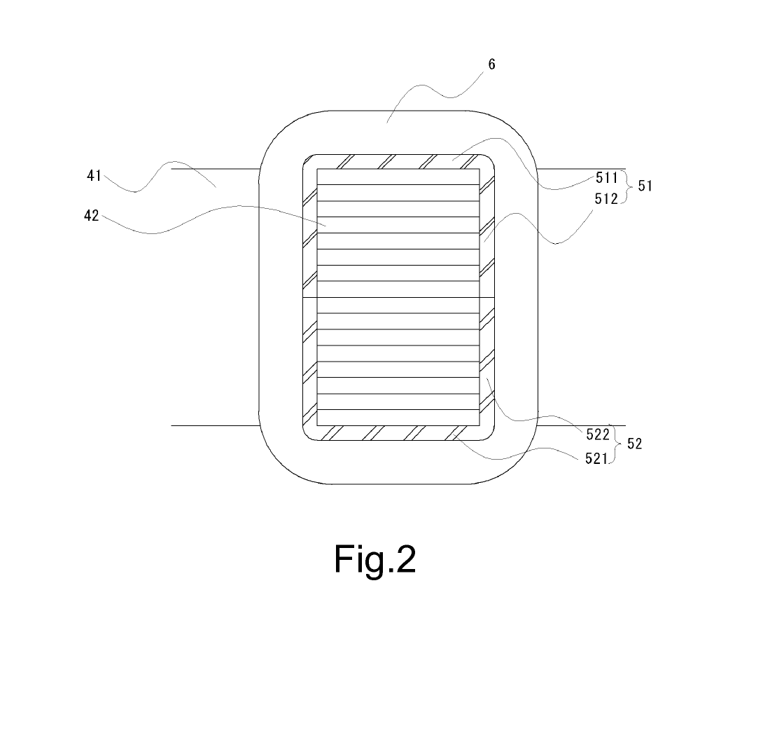

FIG. 2 is a cross-sectional view of a portion of the armature 21 according to the present preferred embodiment taken along a plane perpendicular or substantially perpendicular to a direction of extension of the tooth 42. Here, the plane perpendicular or substantially perpendicular to the direction of the extension of the tooth 42 corresponds to a plane indicated by line A-A′ in FIG. 1.

Referring to FIG. 2, each insulator 5 preferably includes a first resin member 51 arranged to cover an axially upper side of the tooth 42, and a second resin member 52 arranged to cover an axially lower side of the tooth 42. Referring to FIG. 1, the insulator 5 preferably further includes insulator contact surfaces 53 each of which is arranged to face a tip of the tooth 42, accommodating portions 54, insulator tip surfaces 55, and “accommodating portion inner wall surfaces” 56.

The first resin member 51 preferably includes a top plate portion 511 and a pair of upper side wall portions 512. The upper surface of the tooth 42 is covered with the top plate portion 511. The upper side wall portions 512 are arranged to extend downward from both circumferential end portions of the top plate portion 511. Upper regions of both circumferential side surfaces of the tooth 42 are covered with the upper side wall portions 512.

The second resin member 52 preferably includes a bottom plate portion 521 and a pair of lower side wall portions 522. The lower surface of the tooth 42 is covered with the bottom plate portion 521. The lower side wall portions 522 are arranged to extend upward from both circumferential end portions of the bottom plate portion 521. Lower regions of both circumferential side surfaces of the tooth 42 are covered with the lower side wall portions 522. The above structure enables easy attachment of the insulator 5 to the tooth 42.

The insulators 5 are arranged to intervene between the teeth 42 and the coils 6 to more effectively ensure electrical isolation between the teeth 42 and the coils 6.

Each insulator contact surface 53 is preferably defined by a portion of one of the upper side wall portions 512 of the first resin member 51 and a portion of one of the lower side wall portions 522 of the second resin member 52. The insulator contact surface 53 is a surface which extends circumferentially outward in the upper side wall portion 512 of the first resin member 51 and the lower side wall portion 522 of the second resin member 52. In addition, the insulator contact surface 53 is arranged to be at least partly in contact with the projection portion contact surface 4211. This arrangement prevents the insulator 5 from moving toward the tip of the tooth 42 to come off.

The insulator contact surface 53 is preferably arranged at end portions of the upper side wall portion 512 of the first resin member 51 and the lower side wall portion 522 of the second resin member 52 near the tip of the tooth 42. Note, however, that this is not essential to preferred embodiments of the present invention.

Moreover, the insulator contact surface 53 is preferably arranged throughout the upper side wall portion 512 of the first resin member 51 and the lower side wall portion 522 of the second resin member 52. Note, however, that this is not essential to preferred embodiments of the present invention.

Each accommodating portion inner wall surface 56 is arranged to extend from a circumferential end portion of a corresponding one of the insulator contact surfaces 53 toward the tip of the tooth 42.

Each accommodating portion 54 is a portion of the insulator 5, and is a shoulder portion arranged circumferentially outside the upper side wall portion 512 and the lower side wall portion 522. The accommodating portion 54 is arranged to cover the tip portion 4212 of a corresponding one of the projection portions 421 from circumferentially outside. The accommodating portion 54 includes the insulator contact surface and the accommodating portion inner wall surface 56. This structure contributes to more securely fixing the insulator 5 to the tooth 42.

Furthermore, the accommodating portion 54 may be arranged to cover at least a portion of an axial end surface of the tip portion 4212.

Furthermore, each projection portion 421 preferably has a thickness and a width both greater than the thickness of each electromagnetic steel sheet. This facilitates manufacturing of the projection portion 421.

Each insulator tip surface 55 is preferably a surface which extends circumferentially outward from a radial end portion of the insulator 5. The insulator tip surface 55 is preferably has a width d1 greater than a distance d2 from a base to a tip of each projection portion 421 of the tooth 42. This structure contributes to reducing the likelihood of a collapse of the coil 6.

Note, however, that the width d1 of the insulator tip surface 55 may be smaller than the distance d2 from the base to the tip of the projection portion 421 of the tooth 42.

The thickness t1 of a tip portion of the insulator 5 measured in a direction of extension of the tooth 42 is preferably arranged to be greater than the thickness t2 of the projection portion 421 measured in a direction parallel to the direction of the extension of the tooth 42 at an exact midpoint h along the projection of the projection portion 421. This contributes to preventing a pressure on the insulator 5 from causing a significant deformation of the insulator 5.

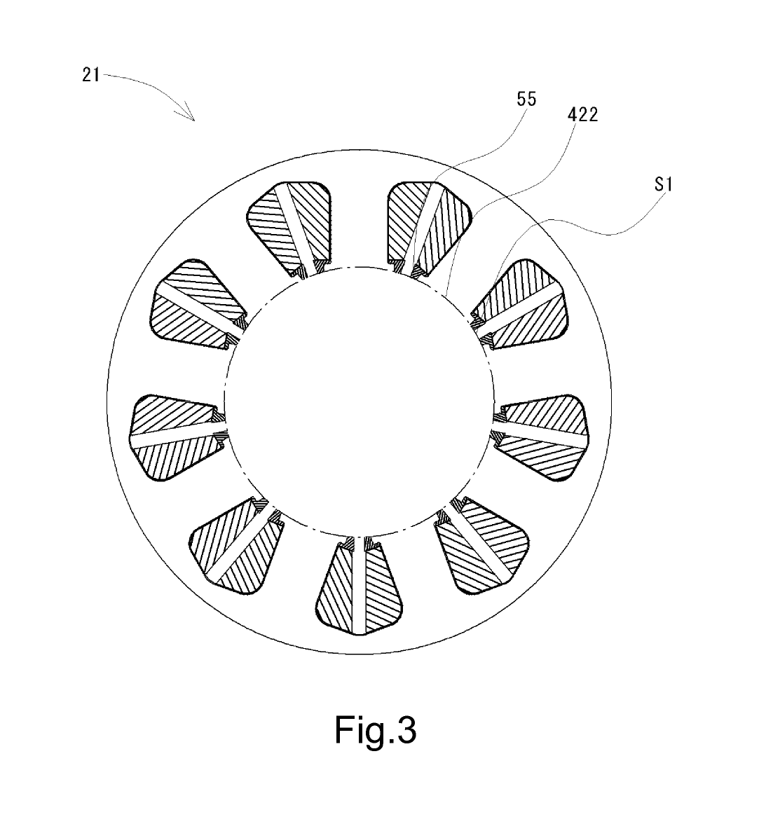

FIG. 3 is a cross-sectional view of the armature 21 of FIG. 1 preferably having an annular or substantially annular shape. Referring to FIG. 3, an envelope S1 is defined by the tooth tip surfaces 422 and the insulator tip surfaces 55. The envelope S1 preferably is cylindrical or substantially cylindrical in shape. This contributes to reducing disturbance of air currents between surfaces of a rotor and the tooth tip surfaces 422.

### Second Preferred Embodiment

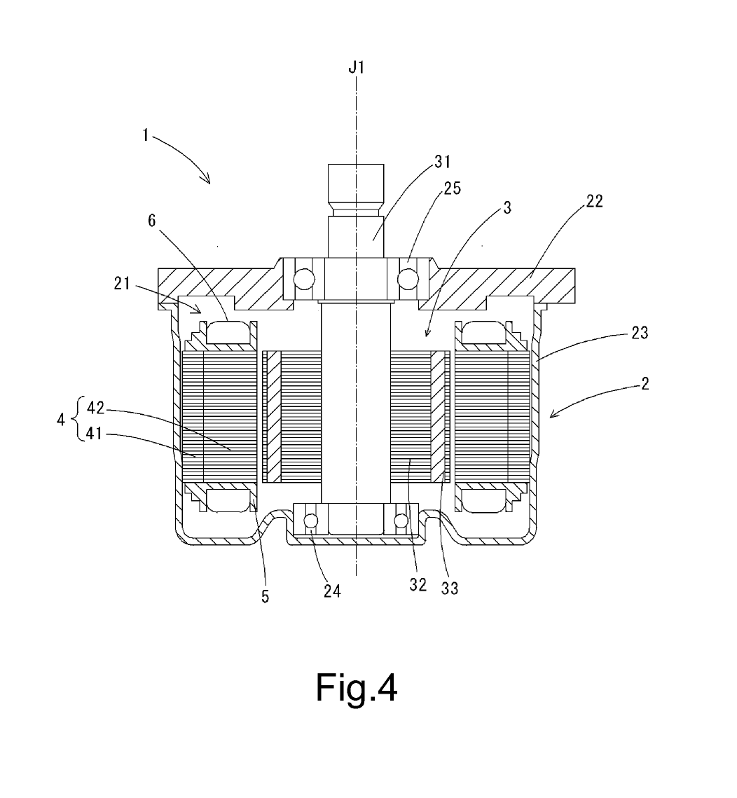

FIG. 4 is a cross-sectional view of a motor 1 according to another preferred embodiment of the present invention. Referring to FIG. 4, the motor 1 preferably includes a stationary portion 2 and a rotating portion 3.

The stationary portion 2 preferably includes the armature 21, a cover portion 22, a housing 23, a lower bearing portion 24, and an upper bearing portion 25.

The armature 21 includes the stator core 4, the insulators 5, and the coils 6. The stator core 4 is preferably defined by, for example, a plurality of electromagnetic steel sheets placed one upon another in the axial direction. Each electromagnetic steel sheet is a magnetic body. The stator core 4 preferably includes the annular core back 41 and the plurality of teeth 42. A central axis of the core back 41 coincides with a central axis J1. The teeth 42 are arranged at regular intervals in the circumferential direction.

The lower bearing portion 24 is arranged between the housing 23 and a shaft 31 of the rotating portion 3. The upper bearing portion 25 is arranged between the cover portion 22 and the shaft 31. A ball bearing which causes an outer race and an inner race to rotate relative to each other through balls is preferably used as each of the lower and upper bearing portions 24 and 25 according to the present preferred embodiment. Note, however, that other types of bearings, such as, for example, plain bearings, fluid bearings, or the like, may be used in place of the ball bearings.

The rotating portion 3 includes the shaft 31, a rotor core 32, and a plurality of magnets 33.

The shaft 31 is a columnar metallic member arranged to extend in the vertical direction. A central axis of the shaft 31 coincides with the central axis J1. The shaft 31 is arranged to rotate while being supported by both the lower and upper bearing portions 24 and 25 described above.

The rotor core 32 and the magnets 33 are arranged radially inside the armature 21, and are arranged to rotate together with the shaft 31. The rotor core 32 preferably is a cylindrical or substantially cylindrical member fixed to the shaft 31.

The magnets 33 are preferably fixed to the rotor core 32 through, for example, an adhesive such that each magnet 33 is arranged radially inward of an outer circumferential surface of the rotor core 32. Note that a cover or the like may be arranged on an axial end surface of each of the magnets 33. The magnets are preferably arranged at regular or substantially regular intervals in the circumferential direction such that north and south pole surfaces alternate with each other.

The armature 21 and the magnets 33 are preferably supported such that the magnets 33 are rotatable about the central axis J1 relative to the armature 21. Once drive currents are supplied to the coils 6 of the armature 21, magnetic flux is generated around each of the teeth 42, and a circumferential torque is produced by interaction between the magnetic flux of the teeth 42 and that of the magnets 33, so that the rotating portion 3 is caused to rotate about the central axis J1 with respect to the stationary portion 2.

While the motor 1 according to the present preferred embodiment of the present invention is preferably an inner-rotor motor, other preferred embodiments of the present invention are also applicable to an outer-rotor motor in which teeth are arranged to extend radially outward and a rotor magnet(s) is arranged radially outside the teeth.

While some preferred embodiments of the present invention have been described above, it will be understood that the present invention is not limited to the above-described preferred embodiments.

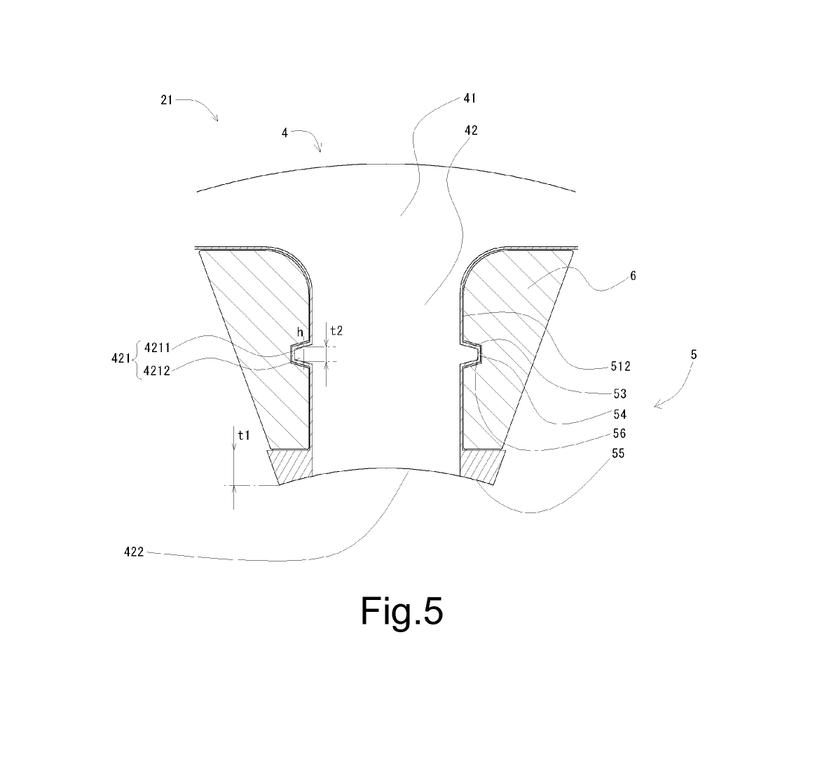

FIG. 5 is a cross-sectional view of a portion of an armature according to another preferred embodiment of the present invention taken along a plane perpendicular or substantially perpendicular to the axial direction. In the preferred embodiment illustrated in FIG. 5, each of projection portions 421 of each of teeth 42 is arranged between a base portion and a tip portion of the tooth 42. This structure contributes to securely fixing an insulator 5 to the tooth 42, and makes it possible to arbitrarily set the circumferential width of the tip portion of the tooth 42 to meet a need of magnetic circuit design.

The insulator 5 preferably includes accommodating portions 54 each of which is in the shape of a groove and is arranged to cover one of the projection portions 421. Each accommodating portion 54 preferably includes an insulator contact surface 53 and an accommodating portion inner wall surface 56. The insulator contact surface 53 is preferably arranged on a side of the projection portion 421 closer to a core back 41. In addition, the insulator contact surface 53 is arranged to be at least partly in contact with the projection portion 421.

Referring to FIG. 5, the radial thickness t1 of a tip portion of the insulator 5 is preferably arranged to be greater than the thickness t2 of the projection portion 421 measured in a direction parallel or substantially parallel to a direction of extension of the tooth 42 at an exact midpoint h along the projection of the projection portion 421. This contributes to preventing a pressure from a coil 6 on the insulator 5 from causing a significant deformation of the insulator 5.

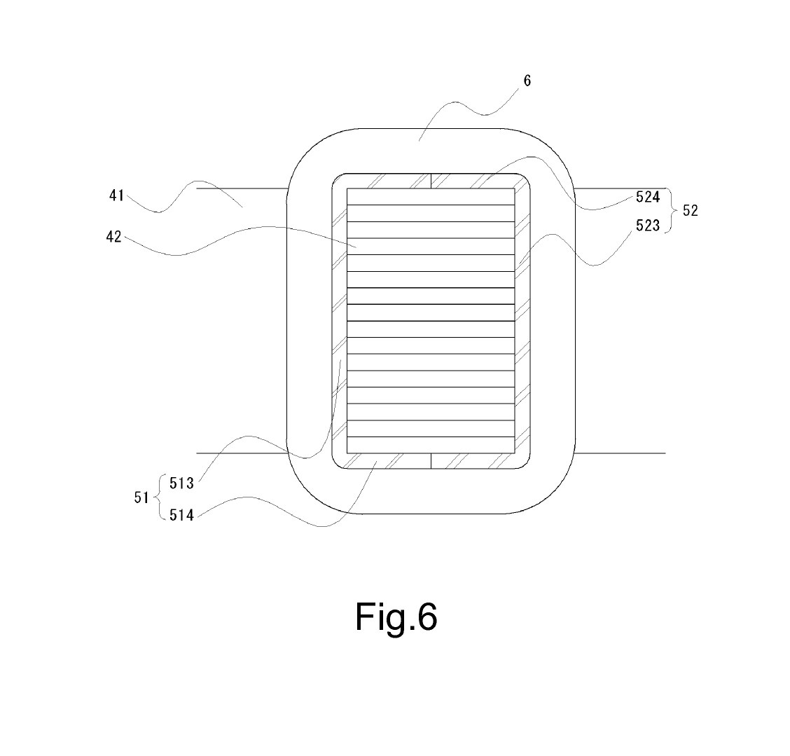

FIG. 6 is a cross-sectional view of a portion of an armature according to yet another preferred embodiment of the present invention taken along a plane perpendicular or substantially perpendicular to a direction of extension of a tooth 42. An insulator 5 according to the preferred embodiment of the present invention illustrated in FIG. 6 preferably includes a first resin member 51 arranged to cover one circumferential side of the tooth 42, and a second resin member arranged to cover an opposite circumferential side of the tooth 42.

The first resin member 51 preferably includes a first side wall portion 513 and a pair of first axial wall portions 514. One circumferential side surface of the tooth 42 is covered with the first side wall portion 513. The first axial wall portions 514 are arranged to extend in the circumferential direction from both axial end portions of the first side wall portion 513. Portions of both axial end surfaces of the tooth 42 are covered with the first axial wall portions 514.

The second resin member 52 preferably includes a second side wall portion 523 and a pair of second axial wall portions 524. An opposite circumferential side surface of the tooth 42 is covered with the second side wall portion 523. The second axial wall portions 524 are arranged to extend in the circumferential direction from both axial end portions of the second side wall portion 523. Portions of both axial end surfaces of the tooth 42 are covered with the second axial wall portions 524. This structure enables easy attachment of the insulator 5 to the tooth 42.

The preferred embodiments of the present invention and modifications thereof are applicable to motors and electric generators.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. An armature comprising:
a stator core including:
an annular core back; and
a plurality of teeth arranged to extend radially inward or radially outward from the annular core back;
insulators, each of which is attached to the stator core and is arranged to cover at least a separate one of the teeth; and
coils, each of which is defined by a conducting wire wound around a separate one of the insulators; wherein each insulator includes a first resin member and a second resin member arranged in an axial direction or a circumferential direction;
each tooth includes a projection portion arranged to extend in the circumferential direction from a circumferential side surface of the tooth;
the projection portion includes a projection portion contact surface arranged to face the core back;
each insulator includes an insulator contact surface arranged to face a tip of a corresponding one of the teeth; and
the insulator contact surface is arranged to be at least partly in contact with the projection portion contact surface of the projection portion of the corresponding tooth.

3. The armature according to claim 2, wherein the projection portion is arranged at a tip portion of the tooth.

4. The armature according to claim 3, wherein
the stator core is defined by steel sheets placed one upon another in the axial direction; and
the projection portion has a thickness and a width which are both greater than a thickness of each steel sheet.

5. The armature according to claim 2, wherein a radial end portion of the insulator has a radial thickness greater than a thickness of the projection portion measured in a direction parallel or substantially parallel to a direction of extension of the tooth at an exact midpoint along a projection of the projection portion.

6. The armature according to claim 2, wherein the insulator further includes an accommodating portion inner wall surface arranged to extend from a circumferential end portion of the insulator contact surface toward a tip of the tooth.

7. The armature according to claim 6, wherein the insulator is arranged to cover a tip portion of the projection portion.

8. The armature according to claim 2, wherein the insulator is arranged to cover an axial end surface of the projection portion.

9. The armature according to claim 2, wherein an envelope defined by tip surfaces of the insulators and tip surfaces of the teeth is cylindrical or substantially cylindrical in shape.

10. The armature according to claim 2, wherein a tip surface of the insulator has a width greater than a distance from a base to a tip of the projection portion.
